(19) United States
(12) Patent Application Publication
(10) Pub. No.: US 2025/0118332 A1
(43) Pub. Date: Apr. 10, 2025

(54) METHOD FOR MANUFACTURING MAGNETIC RECORDING MEDIUM AND HEAT TREATMENT APPARATUS USED THEREFOR

(71) Applicant: Resonac Corporation, Tokyo (JP)

(72) Inventors: Gohei KUROKAWA, Chiba (JP); Kazuki SHINDO, Chiba (JP)

(21) Appl. No.: 18/896,017

(22) Filed: Sep. 25, 2024

(30) Foreign Application Priority Data
Oct. 4, 2023 (JP) 2023-172796

(51) Int. Cl. G11B 5/84

(52) U.S. Cl. CPC G11B 5/84

(57) ABSTRACT

A method for manufacturing a magnetic recording medium includes successively laminating at least a magnetic layer, a protective film, and a lubricant layer on a nonmagnetic substrate, and performing a heat treatment a surface of the lubricant layer by irradiation of light from an LED light source.

### CROSS-REFERENCE TO RELATED APPLICATIONS

This application is based upon and claims priority to Japanese Patent Application No. 2023-172796, filed on Oct. 4, 2023, the entire contents of which are incorporated herein by reference.

### FIELD

Certain aspects of the embodiments discussed herein are related to methods for manufacturing magnetic recording media, and heat treatment apparatuses used therefor.

### BACKGROUND

A hard disk drive (HDD), used as a storage device of an information processing apparatus or the like, includes a magnetic recording medium having a magnetic layer, and a magnetic head for recording information on and reproducing information from the magnetic layer of the magnetic recording medium. In the magnetic recording medium, a protective film and a lubricant layer are provided on the magnetic layer in order to prevent a durability of the magnetic recording medium from deteriorating due to frictional damage caused by sliding contact between the magnetic head and the magnetic head. Conventionally, a hard carbon film is generally used as the protective film. Generally, the lubricant layer is formed by coating a liquid perfluoropolyether compound or the like on a surface of the protective film.

It is known to subject the lubricant layer to various treatments for the purpose of increasing a bonding strength of the lubricant layer with respect to the protective film. For example, Japanese Laid-Open Patent Publication No. H11-25452 discloses a method of performing a heat treatment on the coated lubricant layer, and further performing a light irradiation treatment using an ultraviolet lamp. In addition, Japanese Laid-Open Patent Publication No. H11-25452 also discloses performing the light irradiation treatment in an inert gas atmosphere or in a vacuum, in order to prevent generation of ozone during the light irradiation treatment.

The light irradiation treatment is performed in the inert gas atmosphere or in the vacuum because the light of the ultraviolet lamp will decompose oxygen and generate the ozone. However, it was found that the ozone is still generated slightly, and that the ozone decomposes and destroys lubricant molecules included in the lubricant layer.

By investigating the cause of the generation of ozone, it was found that a small amount of oxygen adsorbed on the surface of the magnetic recording medium enters a treatment apparatus and is decomposed into the ozone. The oxygen, which is a source of the ozone, is derived from moisture adsorbed on the substrate or an inner wall of the treatment apparatus, or from an atmospheric component entering the treatment apparatus even when the inside of the treatment apparatus is the inert gas atmosphere in a case where the lubricant layer is treated in atmosphere (or air), for example. Further, because it is difficult to obtain parallel light from the ultraviolet lamp and the light spreads to the surroundings, the light is irradiated on parts other than the substrate to be treated in the treatment apparatus, thereby causing the oxygen adsorbed on the inner wall or the like of the treatment apparatus to become decomposed into the ozone.

Even if the ultraviolet lamp having a peak wavelength region which does not generate the ozone is used to prevent the decomposition of the oxygen, the ultraviolet lamp includes weak light having various wavelengths other than the peak wavelength, thereby causing the weak light to decompose the oxygen and generate the ozone.

### SUMMARY

Accordingly, it is an object in one aspect of the embodiments to provide a method for manufacturing a magnetic recording medium and a heat treatment apparatus used therefor, which can stably manufacture the magnetic recording medium, by preventing generation of ozone and achieving a good bonding strength between a protective film and a lubricant layer.

According to one aspect of the embodiments, a method for manufacturing a magnetic recording medium, includes successively laminating at least a magnetic layer, a protective film, and a lubricant layer on a nonmagnetic substrate; and performing a heat treatment a surface of the lubricant layer by irradiation of light from an LED light source.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a cross sectional view illustrating an example of a magnetic recording medium;

FIG. 2 is a schematic cross sectional view illustrating an example of a heat treatment apparatus used for manufacturing the magnetic recording medium; and

FIG. 3 is a schematic perspective view illustrating an example of a light source of the heat treatment apparatus.

### DESCRIPTION OF EMBODIMENTS

In order to achieve the object described above, the present disclosure may adopt any one of the following configurations.
[1] A method for manufacturing a magnetic recording medium, comprising:
successively laminating at least a magnetic layer, a protective film, and a lubricant layer on a nonmagnetic substrate; and
performing a heat treatment a surface of the lubricant layer by irradiation of light from an LED light source.
[2] The method for manufacturing the magnetic recording medium according to [1] above, wherein the light emitted from the LED light source has a center wavelength shorter than 500 nm, and the center wavelength excludes a wavelength range of 170 nm to 190 nm.
[3] The method for manufacturing the magnetic recording medium according to [1] or [2] above, wherein the heat treatment is performed under an approximately atmospheric pressure.
[4] The method for manufacturing the magnetic recording medium according to any one of [1] to [3] above, wherein the heat treatment is performed in an atmospheric environment.
[5] The method for manufacturing the magnetic recording medium according to any one of [1] to [4] above, wherein the heat treatment is performed within 60 seconds.
[6] A heat treatment apparatus used in the method for manufacturing the magnetic recording medium according to any one of [1] to [5] above, the heat treatment apparatus comprising:
a first LED source configured to emit light with respect to one surface of the substrate to perform a heat treatment on the substrate;
a second LED source configured to emit light with respect to another surface of the substrate to perform a heat treatment on the substrate; and
a mechanism configured to support an outer peripheral end portion of the substrate by a support member, and move the substrate in and out between the first LED source and the second LED source.
[7] The heat treatment apparatus according to [6] above, wherein 50% or more of the light emitted from the first LED light source and 50% or more of the light emitted from the second LED light source are directly irradiated on the substrate.
[8] The heat treatment apparatus according to [6] or [7] above, wherein a distance between the first LED light source and the substrate and a distance between the second LED light source and the substrate are 50 mm or less.
[9] The heat treatment apparatus according to any one of [6] to [8] above, wherein the light emitted from the first LED light source and the light emitted from the second LED light source have a center wavelength shorter than 500 nm, and the center wavelength excludes a wavelength range of 170 nm to 190 nm.
[10] The heat treatment apparatus according to any one of [6] to [9] above, further comprising:
a controller configured to cause the first LED light source to emit the light and cause the second LED light source to emit the light only when the substrate is placed between the first LED light source and the second LED light source.

Hereinafter, embodiments of the present disclosure will be described with reference to the drawings. In order to facilitate understanding of the description, the same constituent elements (that is, members, components, or the like) are designated by the same reference numerals in the drawings, and a redundant description thereof will be omitted. In addition, the drawings may not necessarily be drawn to scale, and the scale may be different from the actual scale. Furthermore, a numerical range of A to B includes the value A as a lower limit of the numerical range, and the value B as an upper limit of the numerical range, unless indicated otherwise.

Before describing a method for manufacturing a magnetic recording medium according to one embodiment of the present disclosure and a heat treatment apparatus used therefor, the magnetic recording medium obtained by the method for manufacturing the magnetic recording medium according to one embodiment will be described.

### Magnetic Recording Medium

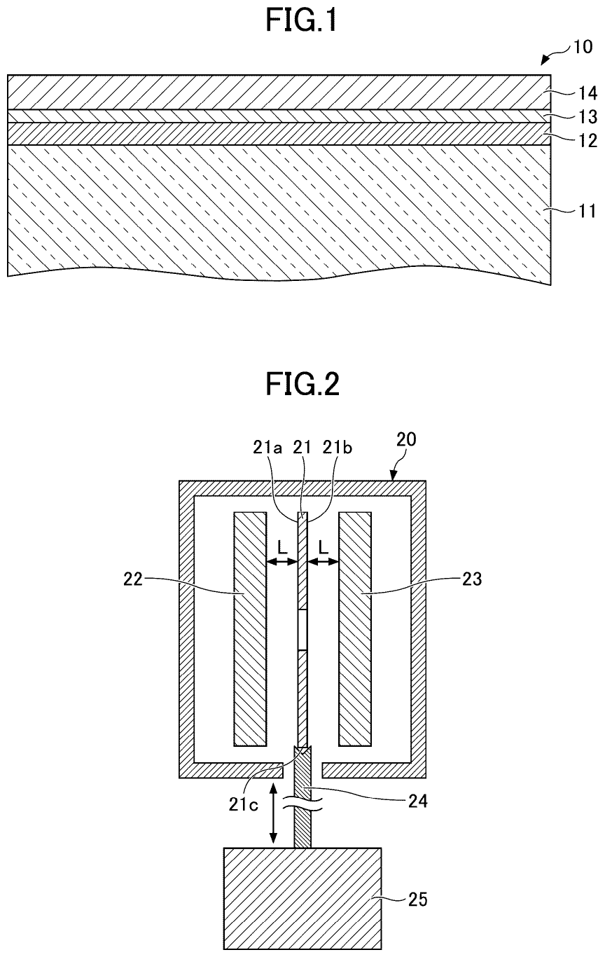

FIG. 1 is a schematic cross sectional view illustrating an example of the magnetic recording medium. As illustrated in FIG. 1, a magnetic recording medium 10 is a laminate having a magnetic layer 12, a protective film 13, and a lubricant layer 14 that are successively laminated on a nonmagnetic substrate 11 in this order.

In the present embodiment, a case where an adhesion layer (not illustrated), a soft magnetic underlayer (not illustrated), a seed layer (not illustrated), and an orientation control layer (not illustrated) are laminated in this order between the nonmagnetic substrate 11 and the magnetic layer 12 will be described as an example. The adhesion layer, the soft magnetic underlayer, the seed layer, and the orientation control layer are provided, as required, and some or all of these layers may be omitted.

A laminate or the like having a film formed of NiP or a NiP alloy formed on a base formed of a metal material, such as Al or the like, or an alloy material, such as an Al alloy or the like, can be used for the nonmagnetic substrate 11. In addition, a substrate formed of a nonmetallic material, such as glass, ceramics, silicon, silicon carbide, carbon, resin, or the like, or a laminate having a film of NiP or a NiP alloy formed on a base formed of a nonmetallic material, can be used for the nonmagnetic substrate 11.

The adhesion layer prevents corrosion of the nonmagnetic substrate 11 from progressing in a case where the nonmagnetic substrate 11 and the soft magnetic underlayer provided on the adhesion layer are disposed in contact with each other. A material used for the adhesion layer can be appropriately selected from Cr, a Cr alloy, Ti, a Ti alloy, or the like, for example. A thickness of the adhesive layer is preferably 2 nm or greater so that effects of providing the adhesive layer can sufficiently be obtained. The adhesion layer can be formed by sputtering, for example.

In this specification, the thickness of the adhesion layer refers to a length of the adhesion layer in a direction perpendicular to a principal surface of the adhesion layer. The thickness of the adhesion layer may be measured at an arbitrary position in a cross section of the adhesion layer. In a case where the thickness is measured at a plurality of arbitrary positions in the cross section of the adhesion layer, the thickness of the adhesion layer may be an average value of the thicknesses at these measurement positions. Thicknesses of the other layers, other than the adhesion layer, can be measured by a method similar to that used to measure the thickness of the adhesion layer.

The soft magnetic underlayer is preferably a laminate having a first soft magnetic film, an intermediate layer formed of a Ru film, and a second soft magnetic film that are successively laminated in this order. That is, the soft magnetic underlayer preferably has a structure in which the two soft magnetic films above and below the intermediate layer, respectively, are anti-ferromagnetically coupled (AFC) by sandwiching the intermediate layer formed of the Ru film between the two soft magnetic films. The soft magnetic underlayer having the AFC structure can improve a resistance to an external magnetic field and a resistance to a wide area track erasure (WATE) phenomenon which is a problem unique to perpendicular magnetic recording.

A thickness of the soft magnetic underlayer is preferably in a range of 15 nm to 80 nm, and more preferably in range of 20 nm to 50 nm. When the thickness of the soft magnetic underlayer is 15 nm or greater, the magnetic flux from the magnetic head can sufficiently be absorbed, and insufficient writing can be prevented, such that a deterioration of recording and reproducing characteristics can be prevented. On the other hand, when the thickness of the soft magnetic underlayer is 80 nm or less, a significant decrease in a productivity can be prevented.

The first soft magnetic film and the second soft magnetic film are preferably formed of a CoFe alloy. In a case where the first soft magnetic film and the second soft magnetic film are formed of the CoFe alloy, a high saturation magnetic flux density Bs (1.4 (T) or higher) can be achieved. In addition, one or more of elements selected from Zr, Ta, and Nb is preferably added to the CoFe alloy used for the first soft magnetic film and the second soft magnetic film. This addition of one or more elements can promote amorphization of the first soft magnetic film and the second soft magnetic film, and can improve an orientation of the seed layer formed on the soft magnetic underlayer and reduce a flying height of the magnetic head.

The soft magnetic underlayer can be formed by sputtering, for example.

The seed layer controls an orientation and a crystal size of the orientation control layer and the magnetic layer 12 provided thereon. The seed layer increases a component of the magnetic flux generated from the magnetic head in a direction perpendicular to a substrate surface, and more firmly fixes a magnetization direction of the magnetic layer 12 in the direction perpendicular to the nonmagnetic substrate 11.

The seed layer is preferably formed of a NiW alloy. In a case where the seed layer is formed of the NiW alloy, other elements, such as B, Mn, Ru, Pt, Mo, Ta, or the like may be added to the NiW alloy, as required.

A thickness of the seed layer is preferably in a range of 2 nm to 20 nm. When the thickness of the seed layer is 2 nm or greater, the effects of providing the seed layer can sufficiently be obtained. On the other hand, when the thickness of the seed layer is 20 nm or less, the crystal size can be prevented from increasing.

The seed layer can be formed by sputtering, for example.

The orientation control layer controls the orientation of the magnetic layer 12 to achieve a good orientation. The orientation control layer is preferably formed of Ru or a Ru alloy. A thickness of the orientation control layer is preferably in a range of 5 nm to 30 nm. When the thickness of the orientation control layer is 30 nm or less, a distance between the magnetic head and the soft magnetic underlayer is reduced, and the magnetic flux from the magnetic head can be made steep. On the other hand, when the thickness of the orientation control layer is 5 nm or greater, the orientation of the magnetic layer 12 can be controlled to achieve a good orientation.

The orientation control layer may be composed of a single layer, or may be composed of a plurality of layers. When the orientation control layer is composed of a plurality of layers, all of the plurality of layers of the orientation control layer may be formed of the same material, or at least a part of the plurality of layers of the orientation control layer may be formed of different materials.

The orientation control layer can be formed by sputtering, for example.

The magnetic layer 12 is composed of a magnetic film having an axis of easy magnetization oriented in the direction approximately perpendicular to the substrate surface of the nonmagnetic substrate 11. The magnetic layer 12 includes Co and Pt, and may further include an oxide, Cr, B, Cu, Ta, Zr, or the like in order to improve a signal-to-noise ratio (SNR) characteristic. Examples of the oxide included in the magnetic layer 12 include SiO₂, SiO, Cr₂O₃, COO, Ta₂O₃, TiO₂, or the like.

The magnetic layer 12 may be composed of a single layer, or may be composed of a plurality of layers having different compositions. For example, in a case where the magnetic layer 12 is composed of three layers including a first magnetic layer, a second magnetic layer, and a third magnetic layer, the first magnetic layer is preferably composed of a material having a granular structure formed of a material including Co, Cr, and Pt and further including an oxide. An oxide of Cr, Si, Ta, Al, Ti, Mg, Co, or the like, for example, is preferably used for the oxide included in the first magnetic layer. Among such oxides, TiO₂, Cr₂O₃, SiO₂, or the like are particularly suitable for use as the oxide. In addition, the first magnetic layer is preferably composed of a composite oxide added with two or more oxides. Among such composite oxides, Cr₂O₃—SiO₂, Cr₂O₃—TiO₂, SiO₂—TiO₂, or the like are particularly suitable for use as the composite oxide.

The second magnetic layer may be formed of the same material as the first magnetic layer. The second magnetic layer is preferably composed of a material having a granular structure.

The third magnetic layer is preferably composed of a material having a nongranular structure formed of a material including Co, Cr, and Pt and including no oxide. The third magnetic layer may include one or more elements selected from B, Ta, Mo, Cu, Nd, W, Nb, Sm, Tb, Ru, Re, and Mn in addition to Co, Cr, and Pt. When the third magnetic layer includes the one or more elements described above in addition to Co, Cr, and Pt, it is possible to promote miniaturization of the magnetic grains or to improve crystallinity and orientation, such that the magnetic recording medium 10 can have recording and reproducing characteristics and thermal stability characteristics which are more suitable for high-density recording.

A thickness of the magnetic layer 12 is preferably in a range of 5 nm to 25 nm. When the thickness of the magnetic layer 12 is 5 nm or greater, a sufficient reproduced output can be obtained and the thermal stability characteristics can be maintained. On the other hand, when the thickness of the magnetic layer 12 is 25 nm or less, it is possible to prevent a size of the magnetic grains in the magnetic layer 12 from increasing, prevent noise during the recording and reproduction from increasing, and prevent deterioration of the recording and reproducing characteristics represented by the SNR and the recording (overwrite (OW)) characteristics.

Further, in order to achieve a higher recording density, the magnetic layer 12 is preferably a magnetic layer for perpendicular magnetic recording having the axis of easy magnetization oriented in the direction approximately perpendicular to the substrate surface of the nonmagnetic substrate 11. The magnetic layer 12 may be for in-plane magnetic recording (or longitudinal magnetic recording).

The magnetic layer 12 may be formed by any of the methods generally used in the prior art, such as vapor deposition, ion beam sputtering, magnetron sputtering, or the like. The magnetic layer 12 is usually formed by sputtering, such as the ion beam sputtering or the magnetron sputtering.

The protective film 13 is provided on an upper surface of the magnetic layer 12 to protect the magnetic layer 12. A carbon-based material, such as chemical vapor deposition (CVD) carbon formed by plasma CVD, amorphous carbon, hydrogen-containing carbon (hydrocarbon), nitrogen-containing carbon, fluorine-containing carbon (fluorocarbon), or the like, and a ceramic-based material, such as silica, zirconia, or the like can be used for the protective film 13. Among such materials, the hard and dense CVD carbon is preferably used for the protective film 13 from a viewpoint of not only the durability but also from the viewpoints of an economic efficiency, the productivity, or the like. A thickness of the protective film 13 is set in a range of 10 Å to 150 Å (1 nm to 15 nm), preferably in a range of 20 Å to 60 Å (2 nm to 6 nm), in order to improve the durability and to reduce a loss during the recording and reproduction.

The lubricant layer 14 is provided on an upper surface of the protective film 13, and is an uppermost layer of the magnetic recording medium 10. The lubricant layer 14 may include a polymer of a polymerizable unsaturated group-containing perfluoropolyether compound, for example. A compound with an organic group having a polymerizable unsaturated bond bonded to at least one end of perfluoropolyether forming a main chain, or the like may be used as the polymerizable unsaturated group-containing perfluoropolyether compound.

### Method for Manufacturing Magnetic Recording Medium

A method for manufacturing the magnetic recording medium according to the present embodiment includes the steps of successively laminating the magnetic layer 12 and the protective film 13 on the nonmagnetic substrate 11 in this order, laminating the lubricant layer 14 on the surface of the protective film 13, and thereafter performing a heat treatment on the surface of the lubricant layer 14 by irradiating light from light emitting diode (LED) light sources (a first LED light source 22 and a second LED light source 23 which will be described later). These steps may be included in a heat treatment process or step. In the method for manufacturing the magnetic recording medium according to the present embodiment, the heat treatment process or step is adopted to stably manufacture the magnetic recording medium, by preventing generation of ozone and achieving a good bonding strength between the protective film 13 and the lubricant layer 14. The effects of increasing the bonding strength between the protective film 13 and the lubricant layer 14 is not only due to the heating effect achieved by the irradiation of light, but also due to increasing a bonding strength between lubricant molecules included in the lubricant layer 14 and the protective film 13 by varying a molecular structure of the lubricant molecules included in the lubricant layer 14 by the irradiation of light from the LED light source. As a result, it is possible to obtain the magnetic recording medium which can achieve a good bonding strength between the protective film 13 and the lubricant layer 14.

That is, because the LED light source can easily obtain parallel light compared with the ultraviolet lamp used in the prior art, and the light can be prevented from spreading to the surroundings and being irradiated on parts other than the substrate to be treated in the treatment apparatus, which may otherwise cause the oxygen adsorbed on the inner wall or the like of the treatment apparatus to become decomposed into ozone. Moreover, because the wavelength range of the emitted light is narrow, it is easy to design a light source that can prevent the generation of ozone caused by decomposition of the oxygen.

The light (LED light) emitted from the LED light source has a center wavelength shorter than 500 nm, and the center wavelength preferably does not include (that is, excludes) a wavelength range of 170 nm to 190 nm. This is because the light having center wavelength in the range of 170 nm to 190 nm decomposes the oxygen to generate the ozone in many cases.

By using such an LED light source, it is possible to prevent the LED light from decomposing the oxygen and generating the ozone. For this reason, in the method for manufacturing the magnetic recording medium according to the present embodiment, the heat treatment can be performed in atmosphere (or air), that is, under an approximately atmospheric pressure or in an atmospheric environment, and a heating device can also be simplified. Thus, a manufacturing cost of the magnetic recording medium and a manufacturing cost of the heating device can be reduced.

Because the LED light source can emit light having an optical directivity, a directivity of heat rays emitted from the LED light source is higher than that of other heating devices or heating means. For this reason, the heat treatment speed can be increased by concentrating the heat rays on the substrate to be processed in the heating apparatus so that the heat rays do not reach members other than the substrate to be processed, such as the support member for the substrate to be processed, the inner wall of the heating apparatus, or the like.

In the method for manufacturing the magnetic recording medium according to the present embodiment, the heat treatment is preferably performed within 60 seconds, and more preferably within 20 seconds. By shortening the treatment time in this manner, the manufacturing cost of the magnetic recording medium can be reduced, and a risk of contamination of the magnetic recording medium during the heat treatment can be reduced.

### Heat Treatment Apparatus

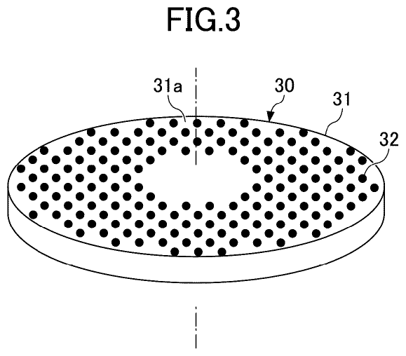

FIG. 2 is a schematic cross sectional view illustrating an example of a heat treatment apparatus used for manufacturing the magnetic recording medium according to one embodiment of the present disclosure, and FIG. 3 is a schematic perspective view illustrating an example of a light source of the heat treatment apparatus. As illustrated in FIG. 2, a heat treatment apparatus 20 includes a first light source 22 configured to emit (irradiate) light (first light) to one surface (heat treatment surface) 21a of a substrate 21 to perform a heat treatment thereon, a second light source 23 configured to emit (irradiate) light (second light) to the other surface (heat treatment surface) 21b of the substrate 21 to perform a heat treatment thereon, and a mechanism 25 configured to support an outer peripheral end portion 21c of the substrate 21 by a support member 24 to move the substrate 21 in and out between the first LED light source 22 and second LED light source 23. In FIG. 2, the mechanism 25 configured to move the substrate 21 and the support member 24 in and out between the first LED light source 22 and second LED light source 23 has a function capable of raising and lowering the substrate 21 in an up-and-down direction indicated by an arrow.

In addition, as illustrated FIG. 3, a LED light source 30, which can configure each of the first LED light source 22 and the second LED light source 23, includes a large number of LED elements 32 attached to a main body 31 of the LED light source 30. The large number of LED elements 32 attached to the main body 31 of the LED light source 30 are arranged so as to face the two heat treatment surfaces 21a and 21b of the substrate 21 illustrated in FIG. 2.

Each LED element 32 is arranged so that light emitted therefrom has an optical directivity with a center axis in a direction perpendicular to a principal surface 31a of the main body 31 of the LED light source 30. The optical directivity of the LED element 32 is preferably ±60° or less with respect to the center axis.

In this example, an angle of the optical directivity of the LED element 32 is defined as an angle with respect to the center axis at which an illuminance becomes 50% in a case where the illuminance of the center axis is 100% when the position at which the LED element 32 emits the brightest light is the center axis. Because an opening is provided at a center of the substrate 21, the LED light source 30 does not need to be provided with the LED element 32 near the center of the main body 31.

As described above, the heat treatment apparatus 20 includes the first LED light source 22 and the second LED light source 23, and by using the LED light source 30 having the configuration illustrated in FIG. 3 as the first LED light source 22 and the second LED light source 23, both surfaces (heat treatment surfaces 21a and 21b) of the substrate 21 can be heat-treated at a high speed. For this reason, the heat treatment apparatus 20 can perform heat treatment on both surfaces of the magnetic recording medium at a high speed by using the magnetic recording medium 10 as the substrate 21, and can thus increase the productivity of the magnetic recording medium 10.

In the heat treatment apparatus 20, it is preferable that 50% or more of the light emitted from the first LED light source 22 and 50% or more of the light emitted from the second LED light source 23 are directly irradiated onto the substrate 21. By adopting such a configuration, the heat treatment apparatus 20 can concentrate the heat rays emitted from the first LED light source 22 and the second LED light source 23 on the substrate 21, and prevent the heat rays from reaching members other than the substrate 21, and can thus increase the treatment speed and prevent generation of impurities.

In the heat treatment apparatus 20, a distance L between the substrate 21 and the first LED light source 22 and between the substrate 21 and the second LED light source 23 is preferably 50 mm or less. By adopting such a configuration, the heat treatment apparatus 20 can concentrate the heat rays emitted from the first LED light source 22 and the second LED light source 23 on the substrate 21, and can thus increase the treatment speed.

In the heat treatment apparatus 20, the light emitted from each of the first LED light source 22 and the second LED light source 23 has the center wavelength shorter than 500 nm, and the center wavelength preferably excludes the wavelength in the range of 170 nm to 190 nm. By making the center wavelength of the light emitted from each of the first LED light source 22 and the second LED light source 23 exclude the wavelength range of 170 nm to 190 nm, it is possible to prevent the generation of ozone caused by decomposition of oxygen.

The heat treatment apparatus 20 can prevent the generation of ozone caused by the decomposition of oxygen by light, by using the first LED light source 22 and the second LED light source 23 having the configuration described above.

The heat treatment apparatus 20 preferably includes a controller configured to cause the first LED light source 22 and the second LED light source 23 to emit light only when the substrate 21 is placed between the first LED light source 22 and the second LED light source 23. A state where the substrate 21 is disposed between the first LED light source 22 and the second LED light source 23 refers to the state where the substrate 21 is disposed at the position illustrated in FIG. 2.

By adopting such a configuration, the heat treatment apparatus 20 can prevent deterioration of the LED light source caused by heat generated by irradiation of light from one of the first LED light source 22 and the second LED light source 23 to the other of the first LED light source 22 and the second LED light source 23. In addition, because the heat treatment apparatus 20 causes the first LED light source 22 and the second LED light source 23 to emit light only during the heat treatment, it is possible to extend a serviceable life of each of the first LED light source 22 and the second LED light source 23 and to reduce the power consumption of the heat treatment apparatus 20.

In the prior art, it is difficult to turn the ultraviolet lamp, which is generally used, on and off within 60 seconds, and it takes approximately one hour for the emission of light to stabilize. In contrast, in the present embodiment, the first LED light source 22 and the second LED light source 23 can easily be turned on and off at a high speed and stably emit light, and for this reason, the heat treatment apparatus 20 can increase the productivity of magnetic recording medium 10 having a good bonding strength between the protective film 13 and the lubricant layer 14, using the first LED light source 22 and the second LED light source 23.

According to one aspect of the embodiments, it is possible to provide a method for manufacturing a magnetic recording medium and a heat treatment apparatus used therefor, which can stably manufacture the magnetic recording medium, by preventing generation of ozone and achieving a good bonding strength between a protective film and a lubricant layer.

In addition, the method for manufacturing the magnetic recording medium according to one aspect of the embodiments can manufacture a magnetic recording medium having a uniform in-plane distribution of the bonding strength between the protective film and the lubricant layer, because the light from the LED light source can have an approximately uniform light intensity on an irradiation surface.

In addition, the heat treatment apparatus according to one aspect of the embodiments can extend a serviceable life of the LED light sources, because the LED light sources emit light only when the substrate to be treated is placed between the pair of LED light sources, and heat rays from one LED light source will not deteriorate the other LED light source. Moreover, the heat treatment apparatus according to one aspect of the embodiments can reduce a power consumption, because the LED light source is caused to emit light only during the heat treatment.

Furthermore, the heat treatment apparatus according to one aspect of the embodiments can increase a productivity of the magnetic recording medium, because the heat treatment apparatus can be used in atmosphere (or air).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for manufacturing a magnetic recording medium, comprising:
successively laminating at least a magnetic layer, a protective film, and a lubricant layer on a nonmagnetic substrate; and
performing a heat treatment a surface of the lubricant layer by irradiation of light from an LED light source.

2. The method for manufacturing the magnetic recording medium as claimed in claim 1, wherein the light emitted from the LED light source has a center wavelength shorter than 500 nm, and the center wavelength excludes a wavelength range of 170 nm to 190 nm.

3. The method for manufacturing the magnetic recording medium as claimed in claim 1, wherein the heat treatment is performed under an approximately atmospheric pressure.

4. The method for manufacturing the magnetic recording medium as claimed in claim 1, wherein the heat treatment is performed in an atmospheric environment.

5. The method for manufacturing the magnetic recording medium as claimed in claim 1, wherein the heat treatment is performed within 60 seconds.

6. A heat treatment apparatus used in the method for manufacturing the magnetic recording medium according to claim 1, the heat treatment apparatus comprising:
a first LED source configured to emit light with respect to one surface of the substrate to perform a heat treatment on the substrate;
a second LED source configured to emit light with respect to another surface of the substrate to perform a heat treatment on the substrate; and
a mechanism configured to support an outer peripheral end portion of the substrate by a support member, and move the substrate in and out between the first LED source and the second LED source.

7. The heat treatment apparatus as claimed in claim 6, wherein 50% or more of the light emitted from the first LED light source and 50% or more of the light emitted from the second LED light source are directly irradiated on the substrate.

8. The heat treatment apparatus as claimed in claim 6, wherein a distance between the first LED light source and the substrate and a distance between the second LED light source and the substrate are 50 mm or less.

9. The heat treatment apparatus as claimed in claim 6, wherein the light emitted from the first LED light source and the light emitted from the second LED light source have a center wavelength shorter than 500 nm, and the center wavelength excludes a wavelength range of 170 nm to 190 nm.

10. The heat treatment apparatus as claimed in claim 6, further comprising:
a controller configured to cause the first LED light source to emit the light and cause the second LED light source to emit the light only when the substrate is placed between the first LED light source and the second LED light source.
